(19) United States
(12) Patent Application Publication
(10) Pub. No.: US 2012/0115605 A1
(43) Pub. Date: May 10, 2012

(54) SYSTEMS AND METHODS FOR INVERSE FRANCHISING OF VIRTUAL CHARACTERS

(75) Inventors: Oliver Watkins, JR., Toronto (CA); Yousuf Chowdhary, Maple (CA); Jeffrey Brunet, Richmond Hill (CA); Ravinder ("Ray") Sharma, Richmond Hill (CA)

(73) Assignee: XMG Studio Inc., Toronto, ON (CA)

(21) Appl. No.: 13/290,452

(22) Filed: Nov. 7, 2011

Related U.S. Application Data
(60) Provisional application No. 61/456,397, filed on Nov. 8, 2010.

(51) Int. Cl. A63F 13/00; A63F 9/24

(52) U.S. Cl. 463/32; 463/42

(57) ABSTRACT

The invention provides a method of providing virtual gameplay with a virtual character in a game environment. A character customization facility is provided within the game environment in which a player can set or select starting attributes for a virtual character, and set or select a graphical avatar of the virtual character. Related gameplay statistics and accumulated gameplay property are stored for the virtual character. The player selects which elements of the starting attributes, the graphical avatar, the gameplay statistics and the gameplay property should be signature elements transferrable with the virtual character beyond the first game in the game environment. Supported signature elements are carried over to a second game.

### RELATED APPLICATION

This application claims priority to U.S. Patent Application No. 61/456,397, filed Nov. 8, 2010, entitled “Systems and Methods for Inverse Franchising of Virtual Characters”, which is incorporated by reference in its entirety herein.

### FIELD OF INVENTION

The present invention is related to video game applications in general and player-created virtual characters for video game applications in particular.

### BACKGROUND

A virtual world is a computer simulated environment. A virtual world may resemble the real world, with real world rules such as physical rules of gravity, geography, topography, and locomotion. A virtual world may also incorporate rules for social and economic interactions between characters. Users may be represented as avatars, two or three-dimensional graphical representations. Virtual worlds may be used for massively multiple online role-playing games, for social or business networking, or for participation in imaginary social universes.

Franchising is a business model in which many different owners share a single brand name. A parent company allows entrepreneurs to use the company's strategies and trademarks; in exchange, the franchisee pays an initial fee and royalties based on revenues. The parent company also provides the franchisee with support, including advertising and training, as part of the franchising agreement. Thus franchising is the practice of using another firm's successful business model including brands, products, pricing etc. and is considered a distribution system.

Franchising is a faster, cheaper form of expansion than adding company-owned stores, since it offers an alternative to building “company owned chain stores” by avoiding investment and liability. Similarly event franchising is the duplication of public events in other geographical areas, while retaining the original brand.

The concept of franchising also extends to movies. In a movie franchise, a series of movies follows the same story line or the same characters through several different story lines. Harry Potter, James Bond, Star Wars, Startrek etc. are all examples of movie franchises.

A media franchise may consist of either a long running series and as well as characters that have been portrayed in many of the episodes (games/movies/cartoon magazines). Some media franchises cross over from their original media form to another. For example, the X-Men was originally a print cartoon franchise, from which a series of movies was created and then several video games were developed using the same storylines. Another example of a media cross over is the video game Golden Eye which was based on a James Bond movie of the same name; while an example a video game series which was later made into a series of movies is the “Resident Evil” series.

There have been attempts to do virtual character franchising in video and computer games. For example, the Mario series incorporates the popular and acclaimed video games by Nintendo, featuring Nintendo's mascot Mario. The series includes over 200 games usually featuring simple plots with gameplay in the series often centering around jumping on and defeating enemies. In this series, Mario retains his physical characteristics/appearance and signature attributes (skills, traits and abilities) from one game to another. However, as a result, the player gameplay experience is static since each player essentially plays with the same virtual character. Thus, the player's experience is essentially the same when playing with a standard franchise character, i.e. Mario is always the same irrespective of who plays it in that particular game. The player has no influence over the character or his behavior.

In virtual character creation, a player selects from a set of predetermined elements to create a virtual character. Generally, the elements relate to the appearance of the virtual character, e.g. the set of predetermined elements can be a list of colors from which the player selects to change the color of the virtual character's hair. In another example, the set of predetermined elements can be a list of outfits from which the player selects to change the virtual character's clothes. Although controlling appearance can be entertaining, the virtual character's behavior is still predetermined by the game and cannot be altered by the player.

Slightly more sophisticated games may allow a player to customize additional elements of the virtual character, with the degree of customization depending on the type of game. For example, in a role playing game, a player may be able to customize a virtual character's strengths or weaknesses in addition to appearance. However, the player is still limited to a finite list of features.

Interactive computer and video games may employ more advanced virtual character creation methods, with animated virtual characters in a virtual world where the player controls the movements and actions of the virtual character, and through the player, the virtual character can interact with other virtual characters. In some such games, the player can employ various input devices to create the virtual character. Typically, a player may select from a variety of virtual character traits that the player wishes the virtual character to have. The game will then generate a virtual character according to the player's selections. The virtual character is generally created using an artificial intelligence engine (AIE) for example one described in US published patent application number 2007/0021200 A1, incorporated herein by reference.

Above described prior art player-created virtual characters belonging to the aforementioned virtual worlds are confined to their respective virtual world and lack the ability to be taken from one virtual world and incorporated into another virtual world. Overcoming these limitations of the prior art would provide a richer gameplay experience and increased continuity of gameplay.

### SUMMARY OF THE INVENTION

The term “Inverse Franchising” as used in this application, implies the exact opposite of the term “Franchising”. In inverse franchising, the virtual character created by the player is distributed from one virtual world to another such that only the player who created it can use it from one virtual world to another. Thus, a player-created virtual character for a first virtual world can be incorporated into a second (or subsequent) virtual world. This contrasts with franchised models of virtual characters, which do not receive significant player input, so that the franchised character (e.g. Mario) is the same across games, irrespective of the player.

When a player has created a virtual character by investing time and effort into it, an emotional bond is created between the player and the created virtual character, which contributes to the increased involvement of the player. A player may be willing to spend more time engaging with the virtual worlds using the said virtual character. A player-created virtual character may also be more unique and distinctive and may reflect a player's gaming style. Thus a player-created virtual character that can be taken from one virtual world to another may further enable a player to have a unique and more enjoyable gaming experience.

Using the methods and systems disclosed in this application, a player can create a virtual character, and then use the same virtual character in more than one virtual world. This provides for a richer gaming experience and increased continuity of gameplay.

According to a first aspect of the invention, a method is provided for providing virtual gameplay with a virtual character in a game environment. The game environment is in communication with a storage means. A game environment is provided which is accessible by at least one player who interacts with the game environment via at least one virtual character. A character customization facility is provided within the game environment in which a player can set or select starting attributes for a virtual character, and set or select a graphical avatar of the virtual character. The set or selected starting attributes and graphical avatar are then saved on the storage means. The actions of the virtual character are monitored as the player plays a first game in the game environment, and related gameplay statistics and accumulated gameplay property are stored for the virtual character on the storage means. Input is received from the player specifying which elements of the starting attributes, the graphical avatar, the gameplay statistics and the gameplay property should be signature elements transferrable with the virtual character beyond the first game in the game environment. When the player selects to play a second game in the game environment with the virtual character, the signature elements of the virtual character are retrievable from the storage means. The game environment automatically determines which of the player's selected signature elements are supported in the second game. The virtual character is then pre-loaded with the supported signature elements in the second game.

The storage means is preferably provided by one or a combination of: a local fixed memory, a local removable memory, a remote fixed memory, a remote removable memory, and a virtual memory. For example, the storage means may be selected from the group consisting of: a local data storage of a game console, a local inbuilt memory, a user provided memory, an online server, and a shared folder on a network.

The starting attributes are preferably selected from the group consisting of: abilities, traits, skills, advantages, disadvantages, powers, and luck. The starting attributes, gameplay statistics and gameplay property may be saved using translatable tags (such as XML tags). Preferably, the signature elements are stored in a string of translatable tags.

These translatable tags are translated into a tag supported by the second game before the second game is started (i.e. at the point of the player selecting to play the second game or at the “determining” step). If no exact match is available, the determining step may include matching at least one signature element with at least one supported element through approximation. Alternatively, the player may be prompted to select from among a plurality of supported elements that approximate the at least one signature element.

Certain statistics may require adjustment in order to make a fair translation of the signature elements from the first game to the second game. In this regard, the determining step may include increasing or decreasing at least one statistic to match at least one signature element to at least one supported element. Further, the player may be queried prior to pre-loading the supported signature elements if the supported signature elements will cause at least one of the virtual character's statistics to start below a default starting statistic in the second game.

Other changes may be entailed as a result of importing the virtual character. For instance, a non-default script may be enabled, unlocked or activated when the virtual character is played in the second game. Scenery, levels or property may also be imported in response to the virtual character being played in the second game.

Preferably, the graphical avatar is rendered in both 2D and 3D when saved. When the second game is invoked, the game environment may select either the 2D or 3D rendering dependent on which is supported in the second game. (The rendering may also be adjusted slightly for each separate game. For example, the clothes may change.)

According to a second aspect of the invention, a method is provided for providing virtual gameplay with a virtual character in a game environment. The game environment is in communication with a storage means. A game environment is provided which is accessible by at least one player who interacts with the game environment via at least one virtual character. A character customization facility is provided within the game environment in which a player can set or select starting attributes for a virtual character, and set or select a graphical avatar of the virtual character. The set or selected starting attributes and graphical avatar are then saved on the storage means. The actions of the virtual character are monitored as the player plays a first game in the game environment, and related gameplay statistics and accumulated gameplay property are stored for the virtual character on the storage means. Input is received from the player specifying which elements of the starting attributes, the graphical avatar, the gameplay statistics and the gameplay property should be signature elements transferrable with the virtual character beyond the first game in the game environment. The system automatically determines which of the player's selected signature elements are supported in a second game. The signature elements are translatable into supported signature elements for the second game, so that the virtual character can be pre-loaded with the supported signature elements at the start of play of the second game.

According to a third aspect of the invention, a method is provided for providing virtual gameplay with a virtual character in a game environment. The game environment is in communication with a storage means. A game environment is provided which is accessible by at least one player who interacts with the game environment via at least one virtual character. A character customization facility is provided within the game environment in which a player can set or select starting attributes for a virtual character. The set or selected starting attributes are then saved on the storage means in the form of a translatable string of XML tags. The actions of the virtual character are monitored as the player plays a first game in the game environment, and related gameplay statistics and accumulated gameplay property are saved for the virtual character in the form of a translatable string of XML tags. Input is received from the player specifying which elements of the starting attributes, the gameplay statistics and the gameplay property should be signature elements transferrable with the virtual character beyond the first game in the game environment. These signature elements are then stored on the storage means in the form of a translatable string of XML tags. The system automatically determines which of the player's selected signature elements are supported in a second game by mapping the XML tags against supported XML tags for the second game. A subset of supported signature elements is generated for the second game, so that the virtual character can be pre-loaded with the supported signature elements at the start of play of the second game.

### BRIEF DESCRIPTION OF THE FIGURES

FIG. 1 is a flow chart representing a first general concept of the invention.

FIG. 2 is a flow chart representing the steps of defining a virtual character and his/her/its related signature elements.

FIG. 3 is a flow chart representing the steps of retrieving, translating and applying the signature elements so that the virtual character can be played in a second game.

FIG. 4 is an example hierarchy of a sample weapon class “Blade” showing tags and scripts.

FIG. 5 is an exemplary screen shot of a character customization screen.

FIGS. 6A-6C illustrate sample statistics for inverse franchising of a virtual character within a sports game environment.

### DETAILED DESCRIPTION

Methods and arrangements for inverse franchising of virtual characters for gaming and virtual worlds are disclosed in this application. The model of “Inverse Franchising”, as used in this application, uses player-created virtual characters. The player-created virtual character can be played in more than one virtual world. Thus player-created virtual characters can be distributed from one virtual world to another such that only the player who created that particular virtual character can use it from one virtual world to another. Using the methods and systems disclosed in this application a player-created virtual character can be exported from one virtual world and imported into another virtual world, such that the virtual character retains its physical characteristics/appearance and other signature elements (including skills, traits and abilities) from one virtual world to another.

Before embodiments of the invention are explained in detail, it is to be understood that the invention is not limited in its application to the details of the examples set forth in the following descriptions or illustrated drawings. The invention is capable of other embodiments and of being practiced or carried out for a variety of applications and in various ways. Also, it is to be understood that the phraseology and terminology used herein is for the purpose of description and should not be regarded as limiting.

Before embodiments of the software modules or flow charts are described in details, it should be noted that the invention is not limited to any particular software language described or implied in the figures and that a variety of alternative software languages may be used for implementation of the invention.

It should also be understood that many components and items are illustrated and described as if they were hardware elements, as is common practice within the art. However, one of ordinary skill in the art, and based on a reading of this detailed description, would understand that, in at least one embodiment, the components comprised in the method and tool are actually implemented in software.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the player's computer, partly on the player's computer, as a stand-alone software package, partly on the player's computer and partly on a remote computer or entirely on the remote computer or server. In the latter scenario, the remote computer may be connected to the player's computer through any type of network, including a local area network (LAN) or a wide area network (WAN), or the connection may be made to an external computer (for example, through the Internet using an Internet Service Provider).

Although the terms “game” and “virtual world” are used somewhat interchangeably herein, a “virtual world” need not be a “game” in the traditional sense of a competition in which a winner and/or loser is determined. Moreover, a virtual character who enters the virtual world in order to conduct business, tour the virtual world, or simply interact with others or the virtual environment, with or without competing against another entity is still considered to be “playing a game.”

Virtual worlds can exist on game consoles for example Microsoft Xbox, and Sony Playstation, Nintendo Wii, etc. or on online servers, or on mobile devices (e.g. an iPhone or an iPad) or on a PC (personal computer) running MS Windows, or MacOS, Linux or another operating system. A computer or a game console that enables a player to engage with a virtual world, including a memory for storing a control program and data, and a processor (CPU) for executing the control program and for managing the data, which includes player data resident in the memory including a set of gameplay statistics. The computer, or a game console, may be coupled to a video display such as a television, monitor, or other type of visual display while other devices may have it incorporated in them (iPad). A game or other simulations may be stored on a storage media such as a DVD, a CD, flash memory, USB memory or other type of memory media. The storage media can be inserted to the console where it is read. The console can then read program instructions stored on the storage media and present a game interface to the player.

Typically, a user or a player manipulates a game controller to generate commands to control and interact with the virtual world. The game controller may include conventional controls, for example, control input devices such as joysticks, buttons and the like. Using the controller a player can interact with the game, such as by using buttons, joysticks, and movements of the controller and the like. This interaction or command may be detected and captured in the game console. The player's inputs can be saved, along with the game data to record the game play. In one embodiment, the gameplay data can include usage statistics captured to record the player's experience as they progress from one level of the game to the next.

The term “player” is intended to describe any entity that accesses the virtual world, regardless of whether or not the player intends to or is capable of competing against other players. Typically, a player will register an account with the game console within a peer-to-peer game and create virtual characters that can interact with other virtual characters of the virtual world.

A “virtual character” may include a persona created by a player or chosen from a list in the virtual world. Typically virtual characters are modeled after the humans whether living or fantasy (e.g. characters from mythology). However, virtual characters can also be non-human entities (e.g. an animal, a tree, a house or building (like a haunted house), a weapon (such as a magic sword)) that are controlled in some respect by a player. Even a collective thing can be a “virtual character” (e.g. an army, a fleet, or an entire sports team), provided that the entity is controlled in some respect by a player.

A virtual character is represented by one or more gameplay statistics, which encapsulate some meaning to connect the virtual (and digital) reality of the game to the real world. Many of these statistics are not apparent to the player as such, but are instead encoded within the framework of the game or composed together to form a script. In role-playing games (RPGs) and similar games, these statistics may be explicitly exposed to the player through a special interface, often with added meaning which provides context for the player's actions.

“Primary statistics” represent assigned, abstract qualities of a virtual character, such as Strength, Intelligence, and so on. Partially defined by convention and partially defined by context, the value of a primary statistic corresponds to a few direct in-game advantages or disadvantages, although a higher statistic is usually better. In this sense, primary statistics can only really be used for direct comparison or when determining indirect advantages and disadvantages.

“Derived statistics” represent measured, concrete qualities of a virtual character, such as maximum carry weight, perceptiveness, or skill with a weapon. Such a stat is derived from some function of one or more of a character's primary stats, usually addition or multiplication. These stats then serve an important function in turn, providing a fair means by which to arbitrate conflicts between virtual characters and the virtual environment. For example, when two virtual characters are in violent conflict, Strength, a primary statistic, might be used to calculate damage, a derived statistic, with the winner being the character that inflicts the most damage on the other.

Other factors may affect derived statistics, such as other derived or primary statistics, or even environmental factors, such as weather conditions. In these cases, the environment can be modeled as a virtual character with its own primary statistics or it may be given a special role in conflict resolution. Whatever-the-case, the role of primary statistics should remain clear because this is the primary interface by which players understand their interactions within the virtual world.

Some statistics deserve special mention. “Health (or Hit Points) vs. Damage,” describes a gameplay mechanic that has fixated the current generation of games. Damage refers to a primary or (usually) derived statistic that represents a character's ability to destroy or cause harm to the environment or virtual characters. Likewise, Health (or Hit Points) refers to a primary or (usually) derived statistic that represents a character's ability to withstand damage and continue to function normally. Each time a character suffers damage, that amount of damage is subtracted from their remaining health or hit point total, and if this total is now zero or less, the character is eliminated or the player loses.

A “statistic” (stat) in role-playing games (RPG) is a datum which represents a particular aspect of a virtual character. Most virtual worlds separate statistics into several categories. The set of categories actually used in a game system, as well as the precise statistics within each category may vary greatly from one virtual world to another. Many virtual worlds also use derived statistics whose values depend on other statistics, which are known as primary or basic statistics. Derived statistics often represent a single capability of the character such as the weight a character can lift, or the speed at which they can move. Derived statistics are often used during combat, can be unitless numbers, or may use real-world units of measurement such as kilograms or meters per second.

A virtual character may have any combination of statistics. A virtual character's statistics affects how it behaves in a virtual world. For example, a well-built muscular virtual character may be more powerful and be able to throw certain virtual objects farther, but at the same time may lack dexterity when maneuvering intricate virtual objects. A virtual character may have any combination of statistics, but these statistics may be limited by either hard counter, soft counters or a combination of both. The most often used types of statistic include but are not limited to the following: attributes; abilities; traits; skills; and advantages/disadvantages.

An “attribute” (or ability) describes to what extent a virtual character possesses a natural, in-born characteristic common to all virtual characters in the game. Ability defines a quality in a virtual character to perform certain actions, for example wield a sword or to run. Many games use attributes to describe a virtual character's physical and mental characteristics, for example their strength or wisdom. Many games also include social characteristics as well, for example a character's natural charisma or physical appearance which often influence the chance to succeed in a particular challenge. Some games work with only a few broad attributes, while others may have several more specific ones. Important to the definition of an attribute is that it represents an abstract, otherwise immeasurable, quantity that may be compared, contrasted, or combined with other attributes to determine certain qualities of a virtual character. These may also be called Ability Scores, Special Statistics, Primary Statistics, etc. in the prior art.

“Traits” may be stable personal characteristics (i.e., temperament or physical endowment) that are additional qualities that help define a virtual character. Traits can be positive or negative. Traits also affect the ability to build particular skills. For instance, an active virtual character will find it easier to develop a more muscular body than an inactive one. Generally a trait represents a broad area of expertise of a character. Some traits are numeric and associated with attributes, while others are more qualitative and not associated with attributes. These may also be called properties, features, descriptors, etc. in the prior art.

A “skill” represents the learned knowledge of a virtual character. Skills are manifestations of abilities and traits. During the creation of a virtual character, skills are generally chosen from a list. A virtual character may have a fixed number of starting skills, or a player can acquire them by spending game points. Each skill has an associated attribute and can be improved upon by practicing. For example, if a virtual character has the ability to wield a sword and has the trait of being physically strong, then the skill of being a swordsman can be accomplished by practicing wielding the sword. As opposed to abilities, few games set a player's skills at the start of the game, instead allowing players to increase them by playing the game and spending game points or during moving from a low level to a higher level in the game. Some skills are likely to be more useful than others therefore different skills often have different costs in terms of game points.

An “advantage” is a physical, social, intellectual, or other enhancement to a virtual character, while a “disadvantage” is an adverse effect. Advantages are also known as virtues, merits or edges and disadvantages as flaws or hindrances. Many games encourage or even force players to take disadvantages for their characters in order to balance their advantages or other positive statistics.

“Powers” represent unique or special qualities of a virtual character and often grant the virtual character the potential to gain or develop certain advantages or to learn and use certain skills.

The term “avatar” is used herein to describe at least the physical embodiment of a virtual character in the virtual world. For example, a virtual character may have an avatar that has a certain appearance and graphical representation in the virtual world. This also applies to the audio representation of a character, or any other sense used to describe virtual characters in a virtual world.

For the purpose of this application, the term “gameplay statistics” refers to any one or any combination of gameplay frequency, gameplay time, number of times game played, percent game complete etc. as result of engaging in gameplay.

The term “engage in gameplay” generally implies playing a game whether it is for the purpose of competing, beating, or engaging with other players. It also means to enter a virtual world in order to conduct business, tour a virtual world, or simply interact with others or a virtual environment, with or without competing against another entity.

Most devices where virtual worlds exist provide a mechanism to save the state of the game, so that the game can be played from the same point where it was left off. Methods for saving the state of the game include but are not limited to the examples cited here, for example a gaming console may provide internal memory chips, or a port where a player can connect player supplied memory; while games played over the Internet may provide online memory. The aforementioned memory space can also be used for saving the statistics/gameplay statistics of the player-created virtual character and his/her/its signature elements across more than one virtual world. Thus the statistics/gameplay statistics of one virtual world are stored as XML code and when another virtual world is evoked the XML code from the first virtual world can be incorporated into the game play and have an effect on the gameplay. XML is but one possible data structure for this kind of record-keeping. The data structure may be a file, e.g. an XML file, or a table, or a database, or a string.

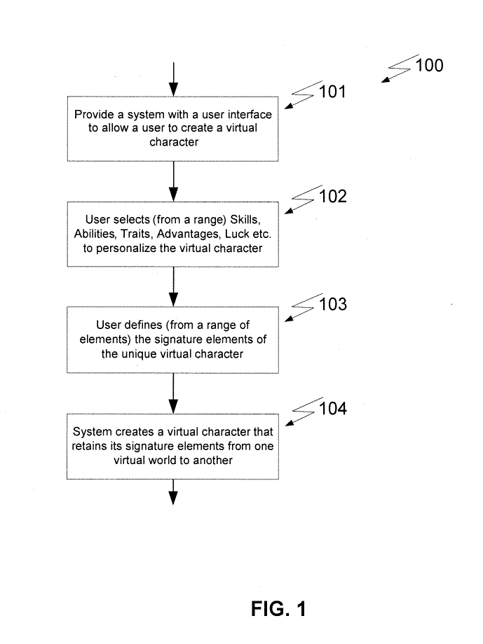

FIG. 1 shows a first conceptual flow 100 of the invention. A user interface is provided to enable a player to create a virtual character on a gaming device 101. The user interface may be a graphical user interface (GUI), or a motion based interface, or voice controlled user interface etc. For the sake of brevity, this application uses the example of a GUI, but the intent is to cover all such possible methods that can be used for this purpose. Gaming devices can include but not limited to an iPhone, iPad, Smartphones, Android phones, personal computers e.g. laptops, gaming consoles like Nintendo Wii, Nintendo DS, Sony PlayStation, Microsoft XBox 360, and online server based games etc.

The computer program comprises: a computer usable medium having computer usable program code, the computer usable program code comprises: computer usable program code for enabling a player to create a virtual character, computer usable program code for presenting graphically to the player the different options available to modify and personalize a virtual character.

Using the user interface (character customization facility) a player sets or selects certain Skills, Traits, Abilities, Advantages, etc. to personalize and make the virtual character unique 102 (e.g. from ranges provided in the user interface). These may also be referred to as “starting attributes”.

In order to retain a balance between virtual characters and the virtual worlds where they may engage in gameplay, a system of a “hard counter” may be used. In such a system every advantage comes with an associated disadvantage or a set of disadvantages. For example a very strong virtual character that can lift heavy weights will automatically lack dexterity and agility.

A “soft counter” is another alternative. With a soft counter, each player when creating a virtual player can only use a maximum number of points (for example 100 points) to create a virtual character. Thus a player is limited to using these points so that a player cannot create a super hero virtual character that can win all games with ease. A blend of the hard and soft counters may be used, i.e. a player can only use up to a maximum number of points when creating a virtual character, and each advantage may have an associated disadvantage.

The player defines or chooses (e.g. from a list of already chosen starting attributes described above) certain signature elements 103 which uniquely define the virtual character. The signature elements can be any player-created or -determined aspects of the virtual character, and are not limited to the starting attributes. Possible signature elements can also include aspects of the character's physical appearance, clothing, personality, catchphrases or modes of expression, playing style, tools or property, etc. Not all of these are necessarily set or defined at the player's first engagement with the game. Some may arise over the course of gameplay or after some length of time playing that virtual character. These signature elements are intended (by the player) to be retained with the virtual character from one virtual world to another. The system may also automatically generate some or all of the signature elements based on the choice of earlier Skills, Traits, Abilities, Advantages etc. chosen by the player to create the virtual character, or through detected patterns in the gameplay. Thus, a virtual character is created that is intended to retain its signature elements from one virtual world to another 104. The system also renders the virtual character in multiple views to allow the fully-fleshed character to be imported from one virtual world to another.

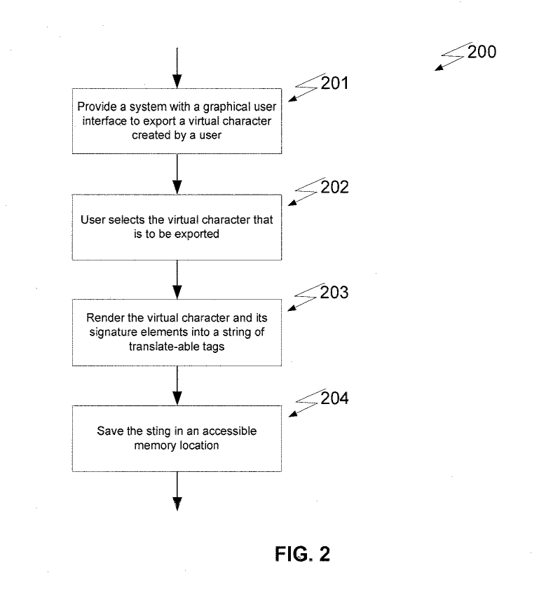

Turning to FIG. 2, a flow chart 200 is provided showing steps of defining a virtual character and his/her/its related signature elements. A system is provided with a graphical interface to export a virtual character 201.

The player selects (defines) a virtual character to be exported 202. A player may use a Graphical User Interface (GUI) or other such mechanism to choose (define) the virtual character that is to be exported. Signature elements are selected as part of this process. The virtual character and his/her/its signature elements are then rendered into a string of translate-able tags 203.

The string of translate-able tags is saved in an accessible memory location 204. An accessible memory location may be the local data storage (internal memory) of a game console or can be local inbuilt memory (for example on board memory) or user provided memory (for example a USB device, a Flash Memory SD card etc.) such that said memory is accessible to other virtual worlds. In another embodiment the memory location may be an online server or a shared folder on a local area network (LAN) etc.

Thus, one possible use of the method is to record and maintain statistics and usage statistics of a virtual character across all of the virtual worlds ever engaged by a specific player on that particular device, (e.g. a mobile device like an iPhone, or a gaming console like XBox 360) including details related to virtual worlds engaged with, including for example, number of times game played, number of points gained, number of lives lost, number of puzzles solved and the time it took to solve these puzzles. The occurrence and outcome of special bonus features, the amounts wagered on any bets, the outcomes for any intermediate game stages, the results of any player decisions made during the game, bonus plays and their outcomes, the final game outcomes etc.

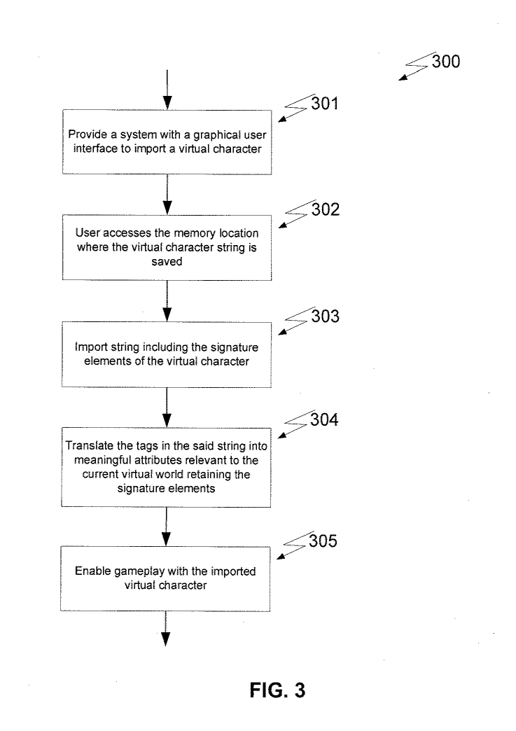

Turning to FIG. 3, a flow chart 300 is provided showing steps of retrieving, translating and applying the signature elements. First, a graphical interface is provided to allow the player to import a virtual character 301. The memory location where the string for the said virtual character is saved 302 is accessed (e.g. by the player directly or by a search function in the program). The accessible memory location may be the local data storage (internal memory) of a game console or can be local inbuilt memory (for example on board memory) or user provided memory (for example a USB device, a Flash Memory SD card etc.) such that said memory is accessible to other virtual worlds. In another embodiment the memory location may be an online server or a shared folder on a local area network (LAN) etc.

The player selects a virtual character to be imported. A player may use a Graphical User Interface for selecting a virtual character or some other such method. The string including the signature elements of the virtual character 303 is imported. The tags in the string are translated into tags that are meaningful and relevant to the current virtual world retaining the signature elements of the virtual character 304. The virtual character is rendered in the current virtual world, and gameplay is enabled with the imported virtual character 305 utilizing the signature elements of the virtual character.

The system may automatically select to proceed with the player-created virtual character to a game if it meets or exceeds a given level of criteria. Or, the system may refuse to allow a player to import a virtual character based on certain criteria (e.g. lack of support for the character's signature elements). If a minimum level is not available (e.g. player defined 5 signature elements but only 3 are available to be used in the virtual world), the player may be allowed to pick a Yes/No whether the player wants to play the game.

Once the character is imported and the supported signature elements are resolved, the player can then engage in gameplay of the current virtual world utilizing the imported player-created virtual character.

Several examples illustrating how a player-created virtual character's signature elements can be transferred from one virtual world to another are given below. First, it is necessary to explain how tags may be used as a particular structure for containing character and property information.

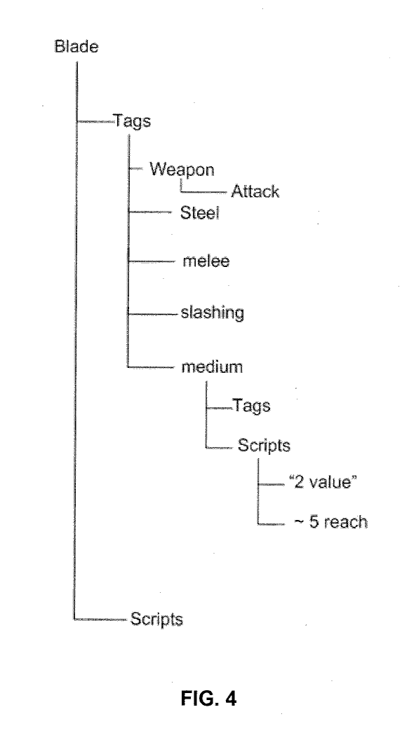

A tag may be composed of other tags, subtags and scripts. An example tag (“Blade”) is shown in FIG. 4. “Blade” is composed of other tags e.g. “weapon”, “steel” and script e.g. a value accessor which returns a value of 2.

The tags “Light”, “Medium” and “Heavy” may be defined as follows for a “Blade”:
“Light” defined by a script”, “1 value, <5 ft. reach”
“Medium” defined by a script”, “2 value, ˜5 ft. reach”
“Heavy” defined by a script”, “3 value, >5 ft. reach”
“Superior” is defined by a script “+1 value”.
“Thrown” is defined by a script “+20 ft. reach” and it includes the tag “ranged” as a subtag.

Some examples follow: If Sword=>blade, a “sword” inherits all the attributes of a “blade” as shown above. If Gladius (short sword)=>superior light blade, a “Gladius” which is composed of tags “superior”, “light” and “blade” inherits all the tags and scripts of a “blade” as shown above and the scripts that defines “light” i.e. “1 value, >5 ft. reach” and “superior” i.e. “+1 value”. This makes it equivalent to a value 2 weapon (a standard medium weapon), but it has less than 5 feet of reach.

If Great Sword=>heavy blade, a “Great Sword” which is composed of tags “heavy”, “blade” inherits all the tags and scripts of a “blade” as shown above and the script that defines “heavy” i.e. “3 value, >5 ft. reach”.

If Halberd=>heavy blade reach, a “halberd” which is composed of tags “heavy”, “blade” and “reach” inherits all the tags and scripts of a “blade” as shown above and the script that defines “heavy” i.e. “3 value, >5 ft. reach” as well as “reach” i.e. “+5 ft. reach”. This makes it have an effective reach of over 10 ft.

If Dagger=>thrown light blade, a “Dagger” which is composed of tags “thrown”, “light” and “blade” inherits some of the tags and scripts of a “blade” as shown above, the script that defines “light” i.e. “1 value, <5 ft. reach,” and the script and tags that define “thrown” i.e. “+20 ft. reach” and “ranged.” This makes it have an effective reach of just less than 25 feet since it's considered a “ranged” weapon instead of a “melee” weapon.

If Knife=>light bladed (blade-like) tool, a “knife” which is composed of tags “light”, “bladed,” and “tool” inherits some of the tags and scripts of a “tool”, and the scripts and tags that define “blade” i.e. “weapon,” “steel,” “melee,” “slashing,” and “medium” as well as the scripts that define “light” i.e. “1 value, <5 ft. reach.” This makes it a slashing tool which can be improvised as a weapon of value 1.

The tags “Light”, “Medium” and “Heavy” may be used universally in a virtual world (game) and the script that defines these tags then provides the relevant meaning. For example, when these tags are used to define a virtual character:

“Light” may be defined by a script, “less than 150 lbs”

“Medium” may be defined by a script, “greater than 150 lbs but less than 200 lbs”

“Heavy” may be defined by a script, “greater than 200 lbs”

Tags define the “qualities” of a player's customized character, where the inherent meaning of these qualities is conserved as much as possible from game to game. Players understand that the in-game implementation of a given tag is game-dependent (as defined by its script), but again these implementations should seem consistent with that of other games that use the same tags.

Values define the “quantities” of a player's customized character, where the relative numerical value of these quantities is conserved as much as possible from game to game. Some games may use inflated or deflated values (such as for score), but proportionately all should be about the same across games with the same values.

Stats are a combination of tags and values specific to a player. Some may be derived or composed of other stats. As a combination of the “qualities” and “quantities” of a player, stats ultimately hold the greatest meaning and personal value for players.

Attributes are the minimal set of stats upon which all other tags and all derived stats are built. A game can thus define associated scripts and appropriately scaled values for a character's signature elements to allow these to be imported between virtual worlds.

To see how these tags can be used to allow virtual character importation across games, take a simple sports example.

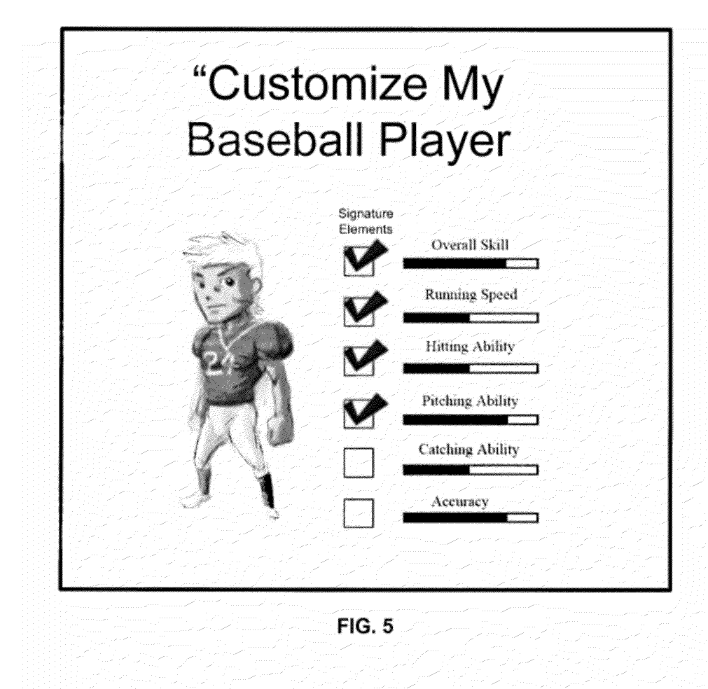

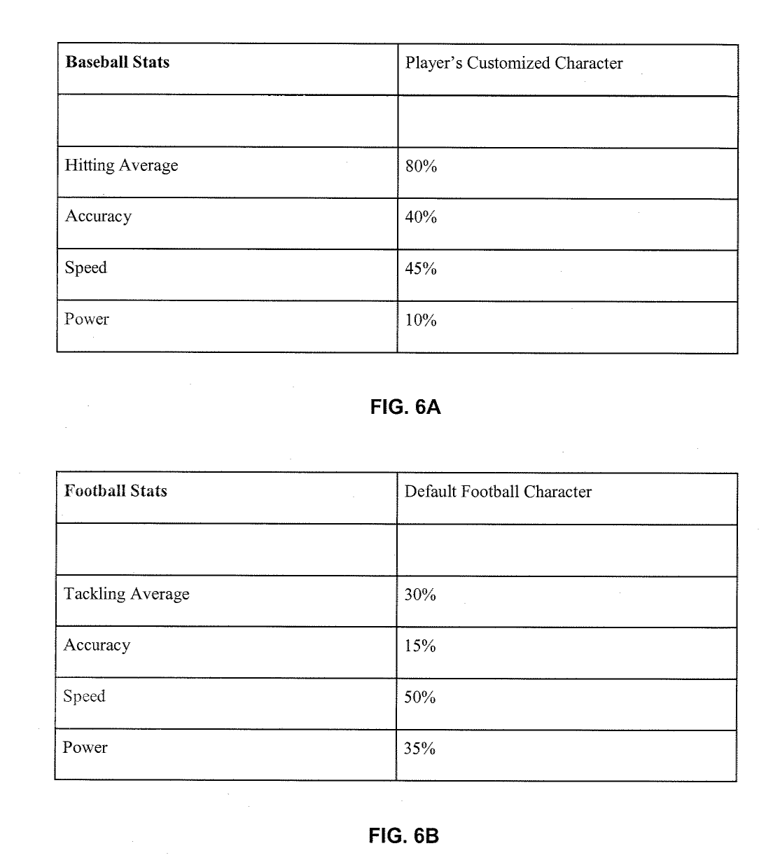

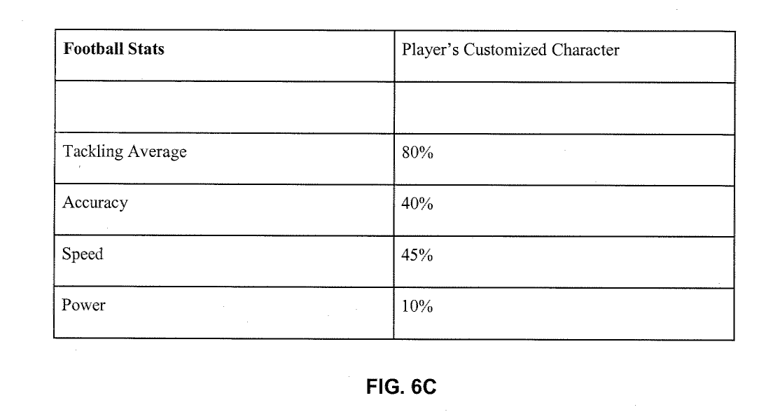

Imagine that a virtual character was created in a “Baseball” game and is being imported into a “Football” game. FIG. 5 shows an example screen where the player is in the process of defining a baseball player and selecting certain signature elements. FIG. 6A shows a player-created virtual character having the certain stats that define its characteristics in “Baseball”.

FIG. 6B shows the stats for a generic (or default) virtual character in the “Football” game.

FIG. 6C shows the effect of importing the player-created “Baseball” character into the “Football” game. As shown in FIG. 6C, when the virtual character is invoked in the “Football” game, certain stats are imported that define its characteristics.

In this case, the stats “Accuracy,” “Speed,” and “Power” are shared by both games, so the player's customized character's corresponding stats from the “Baseball” game can be conserved. In the case of the “Tackling Average” stat, the determination is more complex. First, a stat in these games is defined by a set of tags, a set of scripts, and a percentage particular to the player. The “Hitting Average” from the baseball game has the following tags and associated scripts: “Ball,” “Bat,” “Contact,” “Accuracy,” “Power,” and “Average.” When a stat “Hitting Average” is not found in the “Football” game, it would normally be discarded and the value of the default character would be used for “Tackling Average,” but for the sake of this example, assume that “Hitting Average” was chosen as a signature attribute. So a suitable correspondence must be established depending on the most closely associated tags.

“Tackling Average” is the only stat not yet assigned a value from the stats existing in the player's customized character. It has the following tags and associated scripts: “Full,” “Contact,” “Accuracy,” “Power,” “Average.” A simple intersection function may be used to determine the level of correspondence between two tags, thus in this case we find that “Hitting Average” has the at least one tag in common with the “Accuracy” and “Power” stats, but it has at least four tags in common with the “Tackling Average” stat. Since this signature element of the player's customized character is greater than the alternative stat of the default character, “Hitting Average” is used to replace “Tackling Average” when the player's customized character is imported into a “Football” game.

As can be seen from the comparison of FIGS. 6B and 6C, the customized virtual character that has been imported can start in a more favourable position than would otherwise be available through a default character (even without prior football playing experience!).

Thus, it may be desirable for the default virtual character of the virtual world to be replaced with the player-created virtual character. However, it may also be possible within the game for the player-created virtual character to be engaged in gameplay alongside the default virtual characters of a virtual world.

More complex examples make clear the endless possibilities of this kind of player importation. Let's take an example of a player-created virtual character named “Jungling Joe.” This character's signature elements include the ability to swing from vines, jump from tree to tree, and shoot with bows and arrows. He appears to be a wild, muscled, unkempt man wearing nothing but camouflaging war paint and a loin-cloth that doubles as a quiver, which is supported by jungle vines. When animated, he appears to have an attitude, choosing to solve challenges in the most explosive, dramatic, and over-the-top fashion possible. His tagline is to make frequent, often inappropriate references to the “arrow” in his “package.” In two words, Jungling Joe is a “wild badass”.

As an example, Jungling Joe may have been created in a virtual world “Jungle”, which is used in a 2D side-scrolling platform game. In this virtual world, the player's primary goal is to reach the end of the level without being eaten by one of the many carnivores roaming the jungle floor and canopy. Jungling Joe can use his signature element—the ability to “swing from vines”—to dodge predators and reach the end of the level unharmed.

Assume that the player imports Jungling Joe to a different exemplary virtual world using 2D side-scrolling platform game, “City,” where the premise is that players must reach the end of the level by running and jumping across rooftops while escaping the fire that's running rampart through the city's streets. The default player virtual character for this world might be a burglar called “Robert the Robber.” When Jungling Joe is imported into this virtual world, the system will attempt to match his signature elements with Robert the Robber, or the system may examine which of his signature elements are supported by the game's framework.

The system (game environment) can determine that both Robert the Robber and Jungling Joe possess as a signature element the ability to jump. Further, both of these are side-scrolling platform games, and thus Jungling Joe already possesses the necessary 2D profile graphic to replace Robert the Robber's graphic. The system can then change the gameplay of the virtual world “City” to replace all instances of Robert the Robber with Jungling Joe while preserving the basic premise of the game. That is, Jungling Joe appears to run and jump from rooftop to rooftop while escaping the fire all around him. In a different level of the same virtual world Jungling Joe may swing from chandelier to chandelier in a busy restaurant, to escape opponents. In yet another level Jungling Joe may use an umbrella and ride the smoke coming out of chimneys to escape opponents.

In another example, Jungling Joe is imported into an exemplary virtual world called “Medieval” where the premise is to survive as long as possible while destroying endless waves of attacking henchmen. This game uses a top-down isometric view of a medieval castle. The system can determine that Jungling Joe's signature ability “shooting with a bow and arrows” corresponds with this premise, but that Jungling Joe's graphic is no longer supported from this perspective. The system may then select the next most appropriate graphic, either by reconstructing an isometric 2D graphic from a 3D model, by using one of this game's models as a substitute (perhaps the most scantily clad archer graphic), or some other means.

Thus Jungling Joe may replace the default virtual character of this virtual world, shooting down the waves of attacking henchmen with his bow and arrow. If the “attitude” defining characteristic is supported, then Jungling Joe might opt to feint his opponents by pretending to shoot his bow and arrow before charging and stabbing them in the face.

In another example, Jungling Joe is imported into an exemplary virtual world “Stealth”, where the goal may vary by level, but the task of achieving it usually must be carried out without attracting attention. This game can be played from a first or third person perspective, and contains both combat and platforming related elements (a common theme might be infiltration of a heavily guarded compound). However, since the focus is on remaining hidden from opponents, flashy attacks with a bow and arrow or obvious leaps across a pit might be inappropriate as the sheer number of enemies can simply overwhelm Jungling Joe. Thus the system can determine that some of Jungling Joe's signature elements are partially supported (i.e. his ability to “jump,” or “shoot with a bow and arrows”) while other signature elements are virtually unsupported (i.e. “attitude” since this attracts attention and the virtual character must be trying to avoid it). The only signature element of Jungling Joe which may be fully supported is his “camouflage war paint,” since its effect is both to conceal the character and to make him look badass.

The system may use a more complex process to incorporate Jungling Joe into the exemplary virtual world. Suppose that the default player virtual character of this game is again Robert the Robber, and that one of his signature elements is the ability to use a rope and grappling hook to scale walls and access unconventional entrances. The system can correlate Robert the Robber's “grappling hook” to Jungling Joe's “swinging from vines” signature element, and reconstruct a method to introduce vines to the world. By combining Robert the Robber's ability to climb up and down the rope, as well as Jungling Joe's bow and arrow, vine, loincloth, and attitude, the system can create the desired effect: when it is necessary for Jungling Joe to mimic Robert the Robber's grappling hook ability (such as for reaching a high ledge), the player will see him remove the vine supporting his loincloth, tie it to an arrow, and fire the arrow into the ledge. Jungling Joe can then climb the vine hanging from the arrow to reach the top of the ledge before re-securing his loincloth. Together with appropriately colored war paint, the game can support almost all of Jungling Joe's signature elements while he fulfills the game's premise.

In another example, Jungling Joe is imported into a virtual world “Sci-Fi”, which is a standard Role Playing Game (RPG), where the default virtual characters shoot aliens with laser guns to gain experience points and level up. As these virtual characters gain levels, a variety of player-visible statistics increase as well, possibly according to player decisions. In one scenario the system may reconstruct a method to introduce Jungling Joe into the virtual world, which may require changing elements of the virtual world's storyline, possibly describing Jungling Joe as a primitive man abducted from a savage world for study. This would explain why the scripts and statistics that have always represented Jungling Joe's signature abilities and defining characteristics are only now being revealed to the player and why Jungling Joe interacts with aliens. In this way, undisclosed or hidden aspects of Jungling Joe's signature elements can be re-purposed for a particular use within a virtual world.

Although a bow with arrows compares well to a laser gun in function, it does not compare in effectiveness, and would place Jungling Joe at a distinct disadvantage compared to the default player virtual character. Thus the system may artificially increase the damage of Jungling Joe's bow and arrows to make it comparable to the default player virtual character's laser gun damage. In addition, his damage will increase with each level, just as the default player virtual character's damage does. Other changes might include the speed at which the arrows are launched or whether an arrow can be equipped with other characteristics, e.g. arrows with a fire tip.

In another example, Jungling Joe is imported into a virtual world “Strategy”, where the premise is to manage resources while amassing any army to do battle with an opponent. Just as Jungling Joe's stats and scripts were exposed and adjusted in the RPG, so can they be exposed and adjusted to the virtual world of “Strategy”. In one scenario Jungling Joe may replace a “hero” character within this virtual world, and so the system will evaluate his new stats and scripts to make him comparable to such a virtual character, which is likely to be stronger than a variety of enemies he might face. However, Jungling Joe still cannot defeat an army and since this game requires the player to control multiple characters at once, the system may transfer other characters from other games to assume the remaining roles. For example, if the “hero” character that Jungling Joe is replacing is integral to the storyline and his minions are closely tied to his backstory, then the system may pull the various carnivorous animals from the original “Jungle” game and use them as Jungling Joe's army. These character transfers would be done on a one-to-one basis, just as Jungling Joe was.

In another example, Jungling Joe is imported into a virtual world “Barbie”, where the premise of the game is to dress up barbie in stunning outfits and share them with friends. It is safe to say that none of Jungling Joe's signature elements are fully or partially supported in this virtual world. The system may be able to detect this lack of overlapping characteristics and may prompt the player whether they want to continue knowing that their custom virtual character would not be supported. Supposing that the player opts to continue, the system would then attempt to reconstruct any abilities or characteristics that would be both appropriate for Jungling Joe and Barbie.

It may be beneficial when implementing a virtual world, to specify what abilities a given virtual world object can support, even if the default virtual characters in that virtual world do not possess those abilities.

Exemplary embodiments/implementations of the invention are given below. There may be other methods obvious to persons skilled in the art.

A script defines the default behavior of a virtual character. Just as with statistics, different scripts can refer to different behaviors. A default script of a single virtual character may result in more than one behavior. In fact, the manner by which derived statistics are calculated can itself be defined by a particular script, rather than a simple function. Therefore derived statistics may refer to a particular measurable quality or the behavior that defines that quality.

For example, a skill may be represented by a statistic where a higher value corresponds to a higher degree of skill in some particular endeavor. However, a trait may refer to the behavior that defines that trait, rather than simply a statistic. Hence it may be beneficial, in some scenarios, to distinguish when skills, traits, abilities, and other game components are represented by statistics or behaviors.

When a player-created virtual character is imported into a virtual world, it may use local scripts that already exist in the said virtual world. Alternatively or in combination, all or some scripts may be imported, so that the resulting gameplay is more sophisticated.

Additional scripts that may affect the behavior of an imported player-created virtual character may already be embedded in a virtual world (game), but are dormant, and they may get invoked once a virtual character has been imported. Certain generic scripts for virtual characters may also be based on the role of the said virtual character. For example if the virtual character is a hero a certain set of scripts may be used, and if the virtual character is a villain a certain other set of scripts may be used.

The additional scripts can be imported/exported between two virtual worlds (game) when a virtual character is imported from a first virtual world to a second virtual world. Alternatively, the additional scripts can be downloaded from a central server that acts as a repository for additional scripts. The player may have to pay when acquiring these additional scripts e.g. from a remote server.

A default script may be altered or an alternate script may now be associated with the imported virtual character.

When a player-created virtual character is imported into a virtual world, it may introduce changes in the storyline of the virtual world. For example, the story line may be interactive and the story line may change based on the virtual character imported. If the story line has multiple endings, the ending may be chosen based on the virtual character imported. Of course, the outcome may also be randomized (e.g. the path chosen may be random or may depend on a dice roll).

Another way the story line may be impacted is by a player's gaming style. For example if a player does not like violent games, when said player-created virtual character is imported into a gory virtual world, it can change the story line to be more peaceful or collaborative. A player's gaming style can be defined by player preferences, which may have been captured by either tracking the player gaming style or by asking the player a series of questions, and then the answers from these questions may determine the gaming style which in turn impacts the story line.

Other ways that importation of a virtual character may impact the story line include: skipping levels, moving from one level to the other randomly, or being locked out of odd or even number levels (or other combinations of levels) to change the story line.

The statistics of the player-created virtual character from a first virtual world may be incorporated into statistics for the second virtual world when said virtual character is exported from the first virtual world and imported into the second virtual world.

The player-created virtual character's statistics or gameplay statistics may be exported/imported between virtual worlds. Methods for facilitating this may include saving the player-created virtual character to a memory location that is accessible to the said virtual worlds, from where these virtual worlds can access the player-created virtual character. Thus a player may opt to carry his player-created virtual character on a USB memory key and when engaging with a virtual world may use the virtual character from the said USB memory key. Another example of accessible memory location may be the internal memory of a gaming device/console. Another example may be player provided memory detachably attached to a gaming device (USB key or an Flash memory card), and yet another example is an online server accessible to the gaming device/console where the virtual world is being played, say over a LAN (local area network) or the Internet.

One such method is to save the player-created virtual character's statistics as XML structure that is accessible by multiple virtual worlds (games). The said data structure may be a file e.g. an XML file, or a table, or a database, or a string.

The data fields may be arranged in a given order, so that when a player-created virtual character is exported from one virtual world to another, the virtual world is able to use these statistics in a meaningful and uniform way. Thus the same stats field represents a particular aspect of a virtual character in more than one virtual world. In another embodiment there may be a mapping mechanism that may translate the statistics of the player-created virtual character from the first virtual world to a second virtual world and so forth.

The data structure fields may be ordered to allow virtual characters to correspond uniformly to one another. For example, “Strength” may be the first field in this ordering, “Wisdom” is the second field and so on. When a player-created virtual character is exported/imported between virtual worlds, statistics for the relevant data fields are used to manifest the same function, in this case Strength corresponds to Strength, and Wisdom corresponds to Wisdom etc.

In the alternative or in combination, there may be a mapping mechanism that allows the data structure fields to be mapped indirectly from one to the other so that the relevant data fields correspond with each other. This is especially relevant for derived statistics. For example, if the “Dodge Skill” in one virtual world is composed of the “Dexterity” primary statistic and a “Dodge Training” secondary statistic, and the “Reflex Save” derived statistic in another virtual world is composed of “Dexterity” and “Perception” primary statistics, then the “Dodge Skill” and “Reflex Save” can be composed when virtual characters possessing these statistics are linked by composing the two functions—in which case the new derived statistic will depend on “Dexterity” and may depend on “Dodge Training” and/or “Perception,” depending on which statistics are supported in a given virtual world.

Where there is a non-uniform number of data fields (e.g. one virtual world has a set of statistics with 5 data fields and the second virtual world has a set of statistics with 8 data fields) the mapping allows for the relevant data fields to correspond. This applies much like set intersection, where all shared fields are retained and non-shared fields are retained depending on the level of support for these fields or statistics in a given virtual world.

For each of the statistics that are present in a player-created virtual character, there may be a corresponding value that defines the extent of that particular statistic. For some statistics, the possible range of values may include positive numbers, zero and negative numbers. Thus, when the value is a positive number there may be a beneficial effect (positive effect), while a zero implies no effect and a negative number implies a negative effect.

A framework or an API (Application Programming Interface) may be provided for virtual world creation that allows a developer to incorporate the functionality of player-created virtual character, and the export/import of such virtual characters from one virtual world to another. Using such a framework or API allows for a more uniform virtual world generation, and eventually allows for more complex and extensive ability to import/export player-created virtual character to a larger set of virtual worlds.

It should be understood that although the term game has been used as an example in this application but in essence the term may also imply any other piece of software code where the embodiments of the invention are incorporated. The software application can be implemented in a standalone configuration or in combination with other software programs and is not limited to any particular operating system or programming paradigm described here. For the sake of simplicity, we singled out game applications for our examples. Similarly we described players of these applications as players. There is no intent to limit the disclosure to game applications or player applications. The terms players and players are considered synonymous and imply the same meaning. Likewise, games and applications imply the same meaning. Thus, this application intends to cover all applications and player interactions described above and ones obvious to the ones skilled in the art.

Although virtual character creation has been exemplified above with reference to gaming, virtual character creation affects many industries and applications. For example, virtual character creation can be used in movies, cartoons, computer simulations, and video simulations, among others. All of these industries and applications would benefit from virtual character creation by the player and the ability to be able to engage in with these media using player-created virtual characters.

The examples noted here are for illustrative purposes only and may be extended to other implementation embodiments. While several embodiments are described, there is no intent to limit the disclosure to the embodiment(s) disclosed herein. On the contrary, the intent is to cover all alternatives, modifications, and equivalents obvious to those familiar with the art.

What is claimed is:

1. A method of providing virtual gameplay with a virtual character in a game environment, the game environment being in communication with a storage means, the method comprising the steps of:
providing a game environment accessible by at least one player that interacts with the game environment via at least one virtual character;
providing a character customization facility within the game environment in which a player can set or select starting attributes for a virtual character, and set or select a graphical avatar of the virtual character, the set or selected starting attributes and graphical avatar being saved on the storage means;
monitoring the actions of the virtual character as the player plays a first game in the game environment and saving on the storage means related gameplay statistics and accumulated gameplay property for the virtual character;
receiving input from the player specifying which elements of the starting attributes, the graphical avatar, the gameplay statistics and the gameplay property should be signature elements transferrable with the virtual character beyond the first game in the game environment;
upon the player selecting to play a second game in the game environment with the virtual character, retrieving the signature elements of the virtual character from the storage means, and automatically determining which of the player's selected signature elements are supported in the second game; and
allowing the player to play the second game in the game environment with the virtual character, the virtual character being pre-loaded with the supported signature elements in the second game.

2. The method of claim 1, wherein the starting attributes are selected from the group consisting of: abilities, traits, skills, advantages, disadvantages, powers, and luck.

3. The method of claim 1, wherein the graphical avatar is rendered in both 2D and 3D when saved.

4. The method of claim 1, wherein the starting attributes, gameplay statistics and gameplay property are saved using translatable tags.

5. The method of claim 4, wherein the tags are XML tags.

6. The method of claim 1, wherein the signature elements are stored in a string of translatable tags.

7. The method of claim 4, wherein either the retrieving or the allowing step further comprises translating at least one of the translatable tags into a tag supported by the second game.

8. The method of claim 1, wherein the determining step includes matching at least one signature element with at least one supported element through approximation.

9. The method of claim 1, wherein the determining step includes prompting a player to select from among a plurality of supported elements that approximate the at least one signature element.

10. The method of claim 1, wherein the determining step includes increasing or decreasing at least one statistic to match at least one signature element to at least one supported element.

11. The method of claim 1, wherein the allowing step further comprises enabling, unlocking or activating a non-default script when the virtual character is played in the second game.

12. The method of claim 11, wherein the allowing step further comprises importing scenery, levels or property in response to the virtual character being played in the second game.

13. The method of claim 1, wherein the determining step further comprises selecting either a 2D or 3D rendering of the graphical avatar depending on which is supported in the second game.

14. The method of claim 1, further comprising querying the player prior to pre-loading the supported signature elements if the supported signature elements will cause at least one of the virtual character's statistics to start below a default starting statistic in the second game.

15. The method of claim 1, wherein the storage means is provided by one or a combination of: a local fixed memory, a local removable memory, a remote fixed memory, a remote removable memory, and a virtual memory.

16. The method of claim 1, wherein the storage means is selected from the group consisting of: a local data storage of a game console, a local inbuilt memory, a user provided memory, an online server, and a shared folder on a network.

17. A method of providing virtual gameplay with a virtual character in a game environment, the game environment being in communication with a storage means, the method comprising the steps of:
providing a game environment accessible by at least one player that interacts with the game environment via at least one virtual character;
providing a character customization facility within the game environment in which a player can set or select starting attributes for a virtual character, and set or select a graphical avatar of the virtual character, the set or selected starting attributes and graphical avatar being saved on the storage means;
monitoring the actions of the virtual character as the player plays a first game in the game environment and saving on the storage means related gameplay statistics and accumulated gameplay property for the virtual character;
receiving input from the player specifying which elements of the starting attributes, the graphical avatar, the gameplay statistics and the gameplay property should be signature elements transferrable with the virtual character beyond the first game in the game environment;
automatically determining which of the player's selected signature elements are supported in a second game; and
translating the signature elements into supported signature elements for the second game, so that the virtual character can be pre-loaded with the supported signature elements at the start of play of the second game.

18. A method of providing virtual gameplay with a virtual character in a game environment, the game environment being in communication with a storage means, the method comprising the steps of:
providing a game environment accessible by at least one player that interacts with the game environment via at least one virtual character;
providing a character customization facility within the game environment in which a player can set or select starting attributes for a virtual character, the set or selected starting attributes being saved on the storage means in the form of a translatable string of XML tags;
monitoring the actions of the virtual character as the player plays a first game in the game environment and saving on the storage means related gameplay statistics and accumulated gameplay property for the virtual character in the form of a translatable string of XML tags;
receiving input from the player specifying which elements of the starting attributes, the gameplay statistics and the gameplay property should be signature elements transferrable with the virtual character beyond the first game in the game environment and storing the signature elements on the storage means in the form of a translatable string of XML tags;
automatically determining which of the player's selected signature elements are supported in a second game by mapping the XML tags against supported XML tags for the second game; and
generating a subset of supported signature elements for the second game, so that the virtual character can be pre-loaded with the supported signature elements at the start of play of the second game.
